(19) United States
(12) Patent Application Publication
(10) Pub. No.: US 2025/0136854 A1
(43) Pub. Date: May 1, 2025

(54) COATING COMPOSITE, AND COATED ABRASIVE AND PREPARATION METHOD THEREOF

(71) Applicant: NORTH CHINA UNIVERSITY OF SCIENCE AND TECHNOLOGY, Tangshan, Hebei (CN)

(72) Inventors: Xiongfeng ZENG, Tangshan (CN); Jiansheng WANG, Tangshan (CN)

(21) Appl. No.: 18/574,296

(22) PCT Filed: Oct. 31, 2023
(86) PCT No.: PCT/CN2023/128459

§ 371 Date: Dec. 26, 2023

(51) Int. Cl. C09K 3/14; B24D 3/00; B24D 18/00

(52) U.S. Cl. CPC C09K 3/1436; B24D 3/00; B24D 18/00

(57) ABSTRACT

Provided are a coating composite, and a coated abrasive and a preparation method thereof. The coating composite includes the following components in parts by mass: 100 parts to 120 parts of borate glass, 50 parts to 60 parts of aluminium oxide, 100 parts to 120 parts of potash feldspar, 10 parts to 20 parts of cryolite, and 10 parts to 20 parts of calcium fluoride.

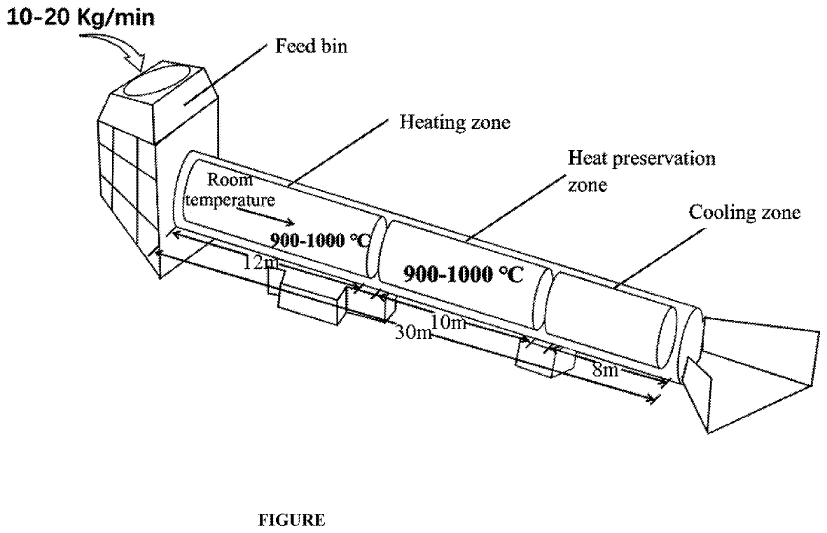

### CROSS REFERENCE TO RELATED APPLICATION

This application is a national stage application of International Patent Application PCT/CN2023/128459, filed on Oct. 31, 2023, the disclosure of which is incorporated herein by reference in its entirety.

### TECHNICAL FIELD

The present disclosure belongs to the technical field of abrasives, and specifically relates to a coating composite, and a coated abrasive and a preparation method thereof.

### BACKGROUND

Abrasives added into a grinding wheel mainly include white corundum, green silicon carbide, cubic boron nitride, diamond, etc. During the use of the grinding wheel, wear is mainly caused by the following factors. 1) Sliding effect between abrasive grains and a workpiece surface: chemical reactions between the abrasive grains and a grinding zone as well as the plastic deformation of the abrasive grains gradually dull the abrasive grains, leading to form a wear surface on the abrasive grains. 2) Abrasive wear: when the stress on the abrasive grains exceeds the inherent strength of the abrasive grains, the abrasive grains may be broken and fall off the grinding wheel, thereby leaving holes in the original positions of the abrasive grains. 3) Clogging and the adhering of the grinding wheel: under the action of high grinding temperature and high contact pressure, materials to be ground may adhere to the abrasive grains, and the adhered materials can stick to the grinding wheel during the grinding, causing the grinding wheel to lose cutting effect. In addition, abrasive debris can also clog pores between the abrasive grains. And, severe clogging may also cause the abrasive grains to be broken and fall off or cause the grinding wheel to lose cutting effect.

In view of this, it is necessary to improve the wear resistance of the abrasives in order to increase the service life of the grinding wheel. To this end, researchers improve the wear resistance of the grinding wheel by coating the abrasives. Coating abrasives is a deep processing process that coats the abrasives by physical or chemical methods. However, the existing coated abrasives still have poor wear resistance.

### SUMMARY

An object of the present disclosure is to provide a coating composite, and a coated abrasive and a preparation method thereof. In the present disclosure, the coating composite could further improve the wear resistance of the coated abrasive.

To achieve the above object, the present disclosure provides the following technical solutions:

The present disclosure provides a coating composite, comprising the following components in parts by mass:

100 parts to 120 parts of borate glass, 50 parts to 60 parts of aluminium oxide, 100 parts to 120 parts of potash feldspar, 10 parts to 20 parts of cryolite, and 10 parts to 20 parts of calcium fluoride.

In some embodiments, the coating composite comprises the following components in parts by mass:

120 parts of the borate glass, 60 parts of the aluminium oxide, 120 parts of the potash feldspar, 10 parts of the cryolite, and 20 parts of the calcium fluoride.

In some embodiments, the coating composite comprises the following components in parts by mass:

100 parts of the borate glass, 50 parts of the aluminium oxide, 100 parts of the potash feldspar, 10 parts of the cryolite, and 10 parts of the calcium fluoride.

In some embodiments, the borate glass has a particle size of 180 mesh to 220 mesh.

In some embodiments, the aluminium oxide has a particle size of 200 mesh to 300 mesh.

In some embodiments, the potash feldspar has a particle size of 180 mesh to 220 mesh.

In some embodiments, the cryolite has a particle size of 180 mesh to 220 mesh.

In some embodiments, the calcium fluoride has a particle size of 200 mesh to 300 mesh.

The present disclosure further provides a coated abrasive, comprising an abrasive and a coating material coated on a surface of the abrasive, where the coating material is the coating composite as mentioned in the above technical solutions.

In some embodiments, the abrasive is one or more selected from the group consisting of white corundum, green silicon carbide, cubic boron nitride, and diamond.

In some embodiments, the abrasive has a particle size of 80 mesh to 120 mesh.

In some embodiments, a mass ratio of the abrasive to the coating material is in a range of 1000:(15-30).

The present disclosure further provides a method for preparing the coated abrasive as mentioned in the above technical solutions, comprising the following steps:
mixing the abrasive, a binder, and the coating material to obtain a mixture, and subjecting the mixture to heat treatment to obtain the coated abrasive, where the coating material is the coating composite mentioned above.

In some embodiments, the binder includes sodium silicate.

In some embodiments, the sodium silicate has a modulus of 1.6 to 2.2.

In some embodiments, a mass ratio of the abrasive, the binder, and the coating material is in a range of 1000:(10-15):(15-30).

In some embodiments, the heat treatment is conducted in a rotary kiln.

In some embodiments, the rotary kiln includes a heating zone, a heat preservation zone, and a cooling zone that are arranged in sequence; and

the heating zone has a length of 12 m, the heat preservation zone has a length of 10 m, and the cooling zone has a length of 8 m.

In some embodiments, the mixture is conveyed at a forward speed of 10 m/h to 15 m/h in the rotary kiln.

In some embodiments, the heating zone has a heating rate of 8° C./min to 15° C./min.

In some embodiments, the heat preservation zone works at 900° C. to 1,000° C.

In some embodiments, the cooling zone has a cooling rate of 5° C./min to 10° C./min.

In some embodiments, the mixture is fed into a rotary kiln at a feeding speed of 10 kg/min to 20 kg/min.

The present disclosure provides a coating composite, comprising the following components in parts by mass: 100 parts to 120 parts of borate glass, 50 parts to 60 parts of aluminium oxide, 100 parts to 120 parts of potash feldspar, 10 parts to 20 parts of cryolite, and 10 parts to 20 parts of calcium fluoride. In the present disclosure, the coating composite could not only eliminate or weaken the stress inside the abrasive through the heat treatment, but also play a desirable role in repairing and bridging micro-cracks on a surface of the abrasive at high temperature during specific applications, thereby greatly improving the inherent strength of the abrasive.

### BRIEF DESCRIPTION OF THE DRAWINGS

FIGURE shows a schematic structural diagram of a rotary kiln in the present disclosure.

### DETAILED DESCRIPTION OF THE EMBODIMENTS

The present disclosure provides a coating composite, comprising the following components in parts by mass:

100 parts to 120 parts of borate glass, 50 parts to 60 parts of aluminium oxide, 100 parts to 120 parts of potash feldspar, 10 parts to 20 parts of cryolite, and 10 parts to 20 parts of calcium fluoride.

In the present disclosure, all components are commercially available products well known to those skilled in the art unless otherwise specified.

In some embodiments of the present disclosure, the coating composite comprises, in parts by mass, 100 parts to 120 parts, more preferably 105 parts to 115 parts, and even more preferably 110 parts of the borate glass. In some embodiments, the borate glass has a particle size of preferably 180 mesh to 220 mesh, more preferably 190 mesh to 210 mesh, and even more preferably 200 mesh.

In some embodiments of the present disclosure, in terms of parts by mass of the borate glass, the coating composite comprises 50 parts to 60 parts, more preferably 52 parts to 58 parts, and even more preferably 55 parts to 56 parts of the aluminium oxide. In some embodiments, the aluminium oxide has a particle size of preferably 200 mesh to 300 mesh, more preferably 220 mesh to 280 mesh, and even more preferably 250 mesh to 260 mesh.

In some embodiments of the present disclosure, in terms of parts by mass of the borate glass, the coating composite comprises 100 parts to 120 parts, more preferably 105 parts to 115 parts, and even more preferably 110 parts of the potash feldspar. In some embodiments, the potash feldspar has a particle size of preferably 180 mesh to 220 mesh, more preferably 190 mesh to 210 mesh, and even more preferably 200 mesh.

In some embodiments of the present disclosure, in terms of parts by mass of the borate glass, the coating composite comprises 10 parts to 20 parts, more preferably 12 parts to 18 parts, and even more preferably 15 parts to 16 parts of the cryolite. In some embodiments, the cryolite has a particle size of preferably 180 mesh to 220 mesh, more preferably 190 mesh to 210 mesh, and even more preferably 200 mesh.

In some embodiments of the present disclosure, in terms of parts by mass of the borate glass, the coating composite comprises 10 parts to 20 parts, more preferably 12 parts to 18 parts, and even more preferably 15 parts to 16 parts of the calcium fluoride. In some embodiments, the calcium fluoride has a particle size of preferably 200 mesh to 300 mesh, more preferably 220 mesh to 280 mesh, and even more preferably 250 mesh to 260 mesh.

In the present disclosure, there is no special limitation on the preparation method of the coating composite, and the raw materials of the coating composite are directly mixed well by stirring; in some embodiments, the stirring is conducted for 15 min.

The present disclosure further provides a coated abrasive, comprising an abrasive and a coating material coated on a surface of the abrasive; where the coating material is the coating composite mentioned above.

In some embodiments of the present disclosure, the abrasive is one or more selected from the group consisting of white corundum, green silicon carbide, cubic boron nitride, and diamond. In some embodiments, the abrasive has a particle size of preferably 80 mesh to 120 mesh, more preferably 90 mesh to 110 mesh, and even more preferably 100 mesh.

In some embodiments of the present disclosure, a mass ratio of the abrasive to the coating material is in a range of 1000:(15-30).

The present disclosure further provides a method for preparing the coated abrasive as mentioned above, comprising the following steps:
mixing the abrasive, a binder, and the coating material to obtain a mixture, and subjecting the mixture to heat treatment to obtain the coated abrasive, where the coating material is the coating composite mentioned above.

In some embodiments of the present disclosure, the binder preferably comprises sodium silicate, and the sodium silicate has a modulus of preferably 1.6 to 2.2, more preferably 1.7 to 2.1, and even more preferably 1.8 to 2.0.

In some embodiments of the present disclosure, a mass ratio of the abrasive, the binder, and the coating material is in a range of preferably 1000:(10-15):(15-30), more preferably 1000:(11-14):(18-28), and even more preferably 1000:(12-13):(20-25).

In some embodiments of the present disclosure, the mixing comprises: mixing the abrasive and the binder to obtain a mixture, and subjecting the mixture to first stirring; and adding the coating material thereto, and subjecting a resulting system to second stirring; In some embodiments, the first stirring is conducted for 5 min; and the second stirring is conducted for 20 min.

In some embodiments of the present disclosure, the heat treatment is preferably conducted in a rotary kiln.

In some embodiments of the present disclosure, the rotary kiln comprises a heating zone, a heat preservation zone, and a cooling zone that are arranged in sequence. And the heating zone has a length of 12 m, the heat preservation zone has a length of 10 m, and the cooling zone has a length of 8 m.

In some embodiments of the present disclosure, the mixture is conveyed at a forward speed of preferably 10 m/h to 15 m/h in the rotary kiln. In some embodiments of the present disclosure, the heating zone has a heating rate of preferably 8° C./min to 15° C./min, and the temperature of the heating zone is raised from room temperature to the temperature of the heat preservation zone. In some embodiments of the present disclosure, the heat preservation zone works at preferably 900° C. to 1,000° C., more preferably 920° C. to 980° C., and even more preferably 950° C. to 960° C. In some embodiments of the present disclosure, the cooling zone has a cooling rate of preferably 5° C./min to 10° C./min, and the temperature of the cooling zone is reduced from the temperature of the heat preservation zone to room temperature.

In some embodiments of the present disclosure, the mixture is fed into a rotary kiln at at a feeding speed of preferably 10 kg/min to 20 kg/min. In some embodiments of the present disclosure, a schematic structural diagram of the rotary kiln used is shown in FIGURE.

In order to further illustrate the present disclosure, the coating composite, and the coated abrasive and the preparation method thereof provided by the present disclosure are described in detail below with reference to the accompanying drawings and examples, but the accompanying drawings and the examples should not be construed as limiting the scope of the present disclosure.

### Example 1

100 parts of borate glass with a particle size of 180 mesh, 50 parts of aluminium oxide with a particle size of 200 mesh, 100 parts of potash feldspar with a particle size of 180 mesh, 10 parts of cryolite with a particle size of 180 mesh, and 10 parts of calcium fluoride with a particle size of 200 mesh were mixed evenly by stirring in a mixer for 15 min to obtain a coating material.

1,000 parts of white corundum with a particle size of 80 mesh as an abrasive and 10 parts of sodium silicate with a modulus of 1.6 as a binder were stirred in a mixer for 5 min, such that the abrasive was fully wetted by the binder. 30 parts of the coating material was added thereto and the resulting system was then further stirred for 20 min, such that the coating material was fully coated on a surface of the abrasive grains to obtain a mixture.

The mixture was continuously fed into a rotary kiln at 10 kg/min, where the rotary kiln had a length of 30 m, and a rotational speed of the rotary kiln was controlled such that the materials in the rotary kiln were conveyed at a forward speed of 10 m/h. Temperature zones of the rotary kiln consisted of a heating zone, a heat preservation zone, and a cooling zone, where the heating zone had a length of 12 m and the temperature of the heating zone was raised from room temperature to 1,000° C. at 10° C./min; the heat preservation zone had a length of 10 m and worked at 1,000° C.; and the cooling zone had a length of 8 m and the temperature of the cooling zone was evenly reduced from 1,000° C. to room temperature at 8° C./min. Materials were fed from the kiln head and then discharged from the kiln end after the heat treatment to obtain a coated abrasive.

The coated abrasive was prepared into a grinding wheel, and the wear resistance of the grinding wheel was tested. The test results are shown in Table 1.

TABLE 1
Performance test results of the coated abrasive

| | Grinding wheel | | | Grinding wheel | | | | Wear |
|---|---|---|---|---|---|---|---|---|
| | diameter (mm) | | | weight (g) | | | Number | of |
| | Before | After | | Before | After | | of | each |
| | cutting | cutting | Loss | cutting | cutting | Loss | cutting | cutting |
| Untreated | 107 | 58 | 49 | 24.6 | 11.3 | 13.3 | 20 | 0.67 |
| white | | | | | | | | |
| corundum | | | | | | | | |
| Coated | 107 | 72 | 35 | 24.3 | 16.1 | 7.9 | 20 | 0.39 |
| abrasive | | | | | | | | |

As shown in Table 1, the coated abrasive provided by the present disclosure significantly improves the service life of the grinding wheel.

### Example 2

120 parts of borate glass with a particle size of 220 mesh, 60 parts of aluminium oxide with a particle size of 300 mesh, 120 parts of potash feldspar with a particle size of 220 mesh, 10 parts of cryolite with a particle size of 220 mesh, and 20 parts of calcium fluoride with a particle size of 300 mesh were mixed evenly by stirring in a mixer for 15 min to obtain a coating material.

1,000 parts of cubic boron nitride with a particle size of 120 mesh as an abrasive and 15 parts of sodium silicate with a modulus of 2.2 as a binder were stirred in a mixer for 5 min, such that the abrasive was fully wetted by the binder. 15 parts of the coating material was added thereto and the resulting system was then further stirred for 20 min, such that the coating material was fully coated on a surface of the abrasive grains to obtain a mixture.

The mixture was continuously fed into a rotary kiln at 20 kg/min, where the rotary kiln had a length of 30 m, and a rotational speed of the rotary kiln was controlled such that the materials in the rotary kiln were conveyed at a forward speed of 15 m/h. Temperature zones of the rotary kiln consisted of a heating zone, a heat preservation zone, and a cooling zone, where the heating zone had a length of 12 m and the temperature of the heating zone was raised from room temperature to 900° C. at 10° C./min; the heat preservation zone had a length of 10 m and worked at 900° C.; and the cooling zone had a length of 8 m and the temperature of the cooling zone evenly reduced from 900° C. to room temperature at 8° C./min. Materials were fed from the kiln head and then discharged from the kiln end after the heat treatment to obtain a coated abrasive.

The coated abrasive was prepared into a grinding wheel, and the wear resistance of the grinding wheel was tested. The test results are shown in Table 2.

TABLE 2
Performance test results of the coated abrasive

| | Grinding wheel | | | Grinding wheel | | | | Wear |
|---|---|---|---|---|---|---|---|---|
| | diameter (mm) | | | weight (g) | | | | of |
| | Before | After | | Before | After | | Number | each |
| | cutting | cutting | Loss | cutting | cutting | Loss | cutting | cutting |
| Untreated cubic | 107 | 64 | 43 | 24.6 | 14.7 | 9.9 | 20 | 0.49 |
| boron nitride | | | | | | | | |
| Coated abrasive | 107 | 78 | 29 | 24.4 | 17.8 | 6.6 | 20 | 0.33 |

As shown in Table 2, the coated abrasive provided by the present disclosure significantly improves the service life of the grinding wheel.

### Comparative Example 1

1,000 parts of white corundum with a particle size of 120 mesh as an abrasive and 15 parts of sodium silicate with a modulus of 2.2 as a binder were stirred in a mixer for 5 min, such that the abrasive was fully wetted by the binder to obtain a mixture.

The mixture was continuously fed into a rotary kiln at 20 kg/min, where the rotary kiln had a length of 30 m, and a rotational speed of the rotary kiln was controlled such that the materials in the rotary kiln were conveyed at a forward speed of 15 m/h. Temperature zones of the rotary kiln consisted of a heating zone, a heat preservation zone, and a cooling zone, where the heating zone had a length of 12 m and the temperature of the heating zone was raised from room temperature to 1,000° C. at 10° C./min; the heat preservation zone had a length of 10 m and worked at 1,000° C.; and the cooling zone had a length of 8 m and the temperature of the cooling zone was evenly reduced from 1,000° C. to room temperature at 8° C./min. Materials were fed from the kiln head and then discharged from the kiln end after the heat treatment to obtain an abrasive.

The abrasive was prepared into a grinding wheel, and the wear resistance of the grinding wheel was tested. The test results are shown in Table 3.

TABLE 3
Performance test results of the abrasive

| | Grinding wheel | | | Grinding wheel | | | | Wear |
|---|---|---|---|---|---|---|---|---|
| | diameter (mm) | | | weight (g) | | | Number | of |
| | Before | After | | Before | After | | of | each |
| | cutting | cutting | Loss | cutting | cutting | Loss | cutting | cutting |
| Comparative | 107 | 62 | 45 | 24.7 | 14.3 | 10.4 | 20 | 0.52 |
| Example 1 | | | | | | | | |
| Example 1 | 107 | 72 | 35 | 24.3 | 16.1 | 7.9 | 20 | 0.39 |

As shown in Table 3, the service life of the abrasive only heat treatmented is not significantly improved.

Although the present disclosure is described in detail in conjunction with the foregoing examples, they are only a part of, not all of, the examples of the present disclosure. Other examples can be obtained based on these examples without inventiveness labour, and all of these examples shall fall within the protection scope of the present disclosure.

1. A coating composite, comprising the following components in parts by mass:
100 parts to 120 parts of borate glass, 50 parts to 60 parts of aluminium oxide, 100 parts to 120 parts of potash feldspar, 10 parts to 20 parts of cryolite, and 10 parts to 20 parts of calcium fluoride.

2. The coating composite according to claim 1, comprising the following components in parts by mass:
120 parts of the borate glass, 60 parts of the aluminium oxide, 120 parts of the potash feldspar, 10 parts of the cryolite, and 20 parts of the calcium fluoride.

3. The coating composite according to claim 1, comprising the following components in parts by mass:
100 parts of the borate glass, 50 parts of the aluminium oxide, 100 parts of the potash feldspar, 10 parts of the cryolite, and 10 parts of the calcium fluoride.

4. The coating composite according to claim 1, wherein the borate glass has a particle size of 180 mesh to 220 mesh;
the aluminium oxide has a particle size of 200 mesh to 300 mesh;
the potash feldspar has a particle size of 180 mesh to 220 mesh;
the cryolite has a particle size of 180 mesh to 220 mesh; and
the calcium fluoride has a particle size of 200 mesh to 300 mesh.

5.-8. (canceled)

9. A coated abrasive, comprising an abrasive and a coating material coated on a surface of the abrasive; wherein the coating material is the coating composite according to claim 1.

10. The coated abrasive according to claim 9, wherein the abrasive is one or more selected from the group consisting of white corundum, green silicon carbide, cubic boron nitride, and diamond.

11. The coated abrasive according to claim 9, wherein the abrasive has a particle size of 80 mesh to 120 mesh.

12. The coated abrasive according to claim 9, wherein a mass ratio of the abrasive to the coating material is in a range of 1000:(15-30).

13. A method for preparing the coated abrasive according to claim 9, comprising the following steps:
mixing the abrasive, a binder and the coating material to obtain a mixture, and subjecting the mixture to heat treatment to obtain the coated abrasive.

14. The method according to claim 13, wherein the binder comprises sodium silicate.

15. The method according to claim 14, wherein the sodium silicate has a modulus of 1.6 to 2.2.

16. The method according to claim 13, wherein a mass ratio of the abrasive, the binder, and the coating material is in a range of 1000:(10-15):(15-30).

17. The method according to claim 13, wherein the heat treatment is conducted in a rotary kiln.

18. The method according to claim 17, wherein the rotary kiln comprises a heating zone, a heat preservation zone, and a cooling zone that are arranged in sequence; and
the heating zone has a length of 12 m, the heat preservation zone has a length of 10 m, and the cooling zone has a length of 8 m.

19. The method according to claim 18, wherein the mixture is conveyed at a forward speed of 10 m/h to 15 m/h in the rotary kiln.

20. The method according to claim 19, wherein the heating zone has a heating rate of 8° C./min to 15° C./min.

21. The method according to claim 18, wherein the heat preservation zone works at 900° C. to 1,000° C.

22. The preparation method according to claim 19, wherein the cooling zone has a cooling rate of 5° C./min to 10° C./min.

23. The method according to claim 13, wherein the mixture is fed into a rotary kiln at a feeding speed of 10 kg/min to 20 kg/min.
